(19) United States
(12) Patent Application Publication
(10) Pub. No.: US 2022/0120775 A1
(43) Pub. Date: Apr. 21, 2022

(54) DISPENSING APPARATUS

(71) Applicant: SHIMADZU CORPORATION, Kyoto-shi (JP)

(72) Inventor: Aya TORAI, Kyoto-shi (JP)

(73) Assignee: SHIMADZU CORPORATION, Kyoto-shi (JP)

(21) Appl. No.: 17/504,791

(22) Filed: Oct. 19, 2021

(30) Foreign Application Priority Data
Oct. 20, 2020 (JP) 2020-175931

(51) Int. Cl. G01N 35/10

(52) U.S. Cl. CPC G01N 35/1011; G01N 2035/103

(57) ABSTRACT

A dispensing apparatus that sucks and discharges liquid through a tip includes a motor, a tip attaching and detaching unit allowing attachment and detachment of a plurality of the tips, a tip holder that holds the plurality of tips, a support member that supports the tip attaching and detaching unit in a displaceable manner, and a drive transmitter that transmits a driving force of the motor to the support member. The drive transmitter includes a transmission switch that switches the drive transmitter from a transmission state in which the driving force of the motor is transmitted to a non-transmission state in which transmission of the driving force of the motor is blocked when an overload on the motor exceeds an upper limit value in a case where the plurality of tips held by the tip holder is attached to the tip attaching and detaching unit along with a displacement of a position of the tip attaching and detaching unit.

### CROSS REFERENCE TO RELATED APPLICATIONS

This application claims priority to Japanese Patent Application No. 2020-175931 filed on Oct. 20, 2020, the entire disclosure of which is incorporated by reference herein.

### BACKGROUND OF THE INVENTION

### Field of the Invention

The present invention relates to a dispensing apparatus.

### Description of the Related Art

Conventionally, some analyzers that perform analysis using a liquid sample, a liquid reagent, or the like include a dispensing apparatus for dispensing the reagent and the sample. An analyzer including a dispensing apparatus can dispense a sample from a sample container or dispense a reagent to be mixed with the sample from a reagent container (see, for example, JP-A-2018-4557).

### SUMMARY OF THE INVENTION

When a sample or the like is dispensed in the above-described dispensing apparatus, a tip is attached to a lower end of a cylinder in advance.

Specifically, a cylinder holder holding at least one or more cylinders is disposed above the tip holder holding at least one or more tips. Upon transmission of driving force of a motor to the cylinder holder, a position of the cylinder holder is displaced to a predetermined position below. When the position of the cylinder holder is displaced, irregularities formed on a lower end of the cylinder and an upper end of the tip are fitted, and the tip is attached to the cylinder.

When the tip is attached to the cylinder, a downward load due to downward displacement of the cylinder holder is applied to the tip and the tip holder. In addition, a drag, that is, an upward load is applied to the cylinder and the cylinder holder. Therefore, a load in a direction opposite to a displacement direction corresponding to driving of the motor is applied to the cylinder holder, and a load is applied to the motor via the cylinder holder.

In particular, in a case where tips are attached to a plurality of the cylinders, the tips are attached to the plurality of cylinders all together, and thus, the load on the motor becomes larger. For example, due to a type of the tips, a difference in quality of the tips, and the tips not correctly set in the tip holder, the load is applied to the motor when the upper ends of some of the tips are located above right positions. Therefore, when the tips are attached to the plurality of cylinders, there is a risk that the motor may step out.

In the dispensing apparatus, when the motor steps out, the dispensing apparatus stops, and the already dispensed sample, reagent, and the like are wasted. In some cases, it is necessary to call a service person. Thus, when the motor steps out in the dispensing apparatus, various troubles occur.

The present invention has been made in view of the above circumstances, and an object of the present invention is to provide a dispensing apparatus capable of reducing a load applied to a motor when a plurality of tips is attached to a tip attaching and detaching unit.

A first aspect of the present invention is a dispensing apparatus that sucks and discharges liquid through a tip, the dispensing apparatus including a motor, a motor controller, a tip attaching and detaching unit allowing attachment and detachment of a plurality of the tips, a tip holder that holds the plurality of tips, a support member, and a drive transmitter including a transmission switch. The motor controller controls the motor. The support member supports the tip attaching and detaching unit in a displaceable manner. The drive transmitter transmits a driving force of the motor to the support member. The transmission switch switches the drive transmitter from a transmission state in which the driving force of the motor is transmitted to a non-transmission state in which transmission of the driving force of the motor is blocked when an overload on the motor exceeds an upper limit value in a case where the plurality of tips held by the tip holder is attached to the tip attaching and detaching unit along with a displacement of the tip attaching and detaching unit.

The present invention can reduce the load applied to the motor when the plurality of tips is attached to the tip attaching and detaching unit.

### BRIEF DESCRIPTION OF THE DRAWINGS

FIG. 1 is a schematic view illustrating a schematic configuration of a dispensing apparatus according to an embodiment of the present invention as viewed from a side surface;

FIG. 2 is a block diagram illustrating an example of an electrical configuration of a dispensing apparatus according to an embodiment of the present invention;

FIG. 3 is a sectional view illustrating an example of a schematic configuration of a periphery of a transmission switch according to an embodiment of the present invention;

FIG. 4 is a sectional view illustrating another example of a schematic configuration of a periphery of a transmission switch according to an embodiment of the present invention;

FIG. 5 is a schematic view illustrating a schematic configuration of a periphery of a pressing plate and a rotating member according to an embodiment of the present invention as viewed obliquely;

FIG. 6 is a diagram illustrating an example of a memory map of a RAM according to an embodiment of the present invention;

FIG. 7 is a block diagram specifically illustrating an electrical configuration of a dispensing apparatus according to an embodiment of the present invention; and

FIG. 8 is a flowchart illustrating an example of switching processing of a CPU according to an embodiment of the present invention.

### DETAILED DESCRIPTION OF THE PREFERRED EMBODIMENTS

### 1. Overall Configuration of Dispensing Apparatus

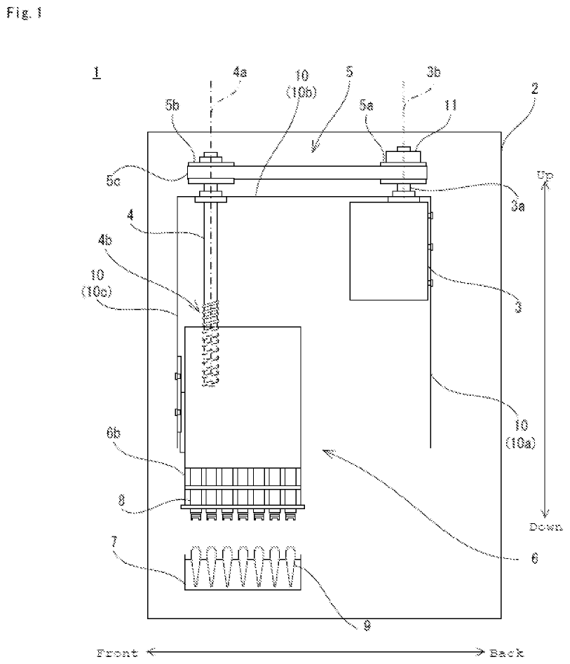

FIG. 1 is a schematic view illustrating a schematic configuration of a dispensing apparatus 1 according to an embodiment of the present invention as viewed from a side surface. Note that FIG. 1 illustrates only a configuration required when a tip 9 is attached to a cylinder 8. FIG. 1 is also a diagram illustrating a state before the tip 9 is attached to the cylinder 8.

The dispensing apparatus 1 according to the present embodiment includes a motor 3, a support member 4, a drive transmitter 5, a tip attaching and detaching unit 6, and support plates 10 (10a, 10b, and 10c) in a housing 2, and drives the motor 3 to displace a position of the tip attaching and detaching unit 6 and attach the tip 9 to the cylinder 8.

The motor 3 is supported by the support plate 10a via a support member on a back side in the housing 2. In the embodiment, a stepping motor is used as the motor 3. As the motor 3, another general-purpose motor may be used.

The motor 3 includes a cylindrical motor shaft 3a. When the motor 3 is driven, the motor shaft 3a rotates about a rotation axis 3b.

The support member 4 is rotatably supported by the support plate 10b via a support member on a front side in the housing 2, and rotates about a rotation axis 4a parallel to the rotation axis 3b.

The drive transmitter 5 is provided to transmit a driving force of the motor 3 to the support member 4. In the embodiment, the drive transmitter 5 includes a driving pulley 5a, a driven pulley 5b, and an annular belt 5c. The driving pulley 5a and the driven pulley 5b are general-purpose pulleys.

The driving pulley 5a is provided coaxially with the rotation axis 3b. Specifically, the driving pulley 5a is provided on an outer peripheral surface of the motor shaft 3a rotating about the rotation axis 3b. That is, the driving pulley 5a rotates about the rotation axis 3b. In some cases, the driving pulley 5a is provided on the outer peripheral surface of the motor shaft 3a via another member or the like.

The driven pulley 5b is provided coaxially with the rotation axis 4a. Specifically, the driven pulley 5b is provided on an outer peripheral surface of the support member 4 rotating about the rotation axis 4a. That is, the driven pulley 5b rotates about the rotation axis 4a. The driven pulley 5b is provided at a position aligned with the driving pulley 5a in a horizontal direction on the rotation axis 4a. In some cases, the driven pulley 5b is provided on the outer peripheral surface of the support member 4 via another member or the like.

The belt 5c is provided on outer peripheral surfaces of the driving pulley 5a and the driven pulley 5b with a tension applied, that is, without being bent. Therefore, when the motor shaft 3a rotates in response to the driving of the motor 3, the driving force of the motor 3 is transmitted to the support member 4, and the support member 4 rotates.

The support member 4 supports the tip attaching and detaching unit 6 in a displaceable manner. Teeth 4b that function as a screw are formed at a lower end of the support member 4. The teeth 4b of the support member 4 are mechanically connected to the tip attaching and detaching unit 6 via a nut (not illustrated). Here, a position of the nut is displaced in a vertical direction in accordance with the rotation of the support member 4. Furthermore, a position of the tip attaching and detaching unit 6 connected to the nut is also displaced similarly.

The tip attaching and detaching unit 6 is slidably supported in the vertical direction by the support plate 10c via a support member such as a rail. Further, as described above, since the position of the tip attaching and detaching unit 6 is displaced in the vertical direction by the rotation of the support member 4, for example, when the support member 4 rotates forward, the position of the tip attaching and detaching unit 6 is displaced downward. That is, when the support member 4 rotates forward, the tip attaching and detaching unit 6 approaches a tip holder 7. When the support member 4 rotates backward, the position of the tip attaching and detaching unit 6 is displaced upward. That is, the tip attaching and detaching unit 6 is separated from the tip holder 7.

The tip attaching and detaching unit 6 includes a cylinder holder 6b that holds a plurality of the cylinders 8, and the plurality of cylinders 8 is arranged in a matrix in the cylinder holder 6b.

The tip holder 7 is provided to hold a plurality of the tips 9. In the tip holder 7, the plurality of tips 9 is arranged in a matrix.

Each of the tips 9 has a cylindrical shape elongated in an up-down direction, and in particular, a lower end of each tip 9 has a tapered shape.

When the tips 9 are attached to the plurality of cylinders 8, the tip holder 7 is disposed below the tip attaching and detaching unit 6 as illustrated in FIG. 1. When the tip holder 7 is disposed below the tip attaching and detaching unit 6, the tip attaching and detaching unit 6 is displaced downward, and irregularities formed at lower ends of the cylinders 8 and irregularities formed at upper ends of the tips 9 are fitted, and therefore the tips 9 are attached to the cylinders 8.

Although not illustrated, a piston is provided in each cylinder 8. When the piston moves up and down with the tips 9 attached to the cylinders 8, for example, liquid (sample, reagent, or the like) is sucked by the tips 9. The liquid sucked by the tips 9 is held in the tips 9. Further, the liquid held in the tips 9 can be discharged by moving the pistons up and down.

In the embodiment, the drive transmitter 5 includes the transmission switch 11. The transmission switch 11 is provided to switch the drive transmitter 5 from a transmission state in which the driving force of the motor 3 is transmitted to a non-transmission state in which the transmission of the driving force of the motor 3 is blocked when an overload on the motor 3 exceeds an upper limit value.

In the embodiment, a torque limiter is used as the transmission switch 11. The transmission switch 11 is provided on the rotation axis 3b. Specifically, the transmission switch 11 is provided on the outer peripheral surface of the motor shaft 3a rotating about the rotation axis 3b. In some cases, the transmission switch 11 is provided on the outer peripheral surface of the motor shaft 3a via another member or the like.

### 2. Electrical Configuration of Dispensing Apparatus

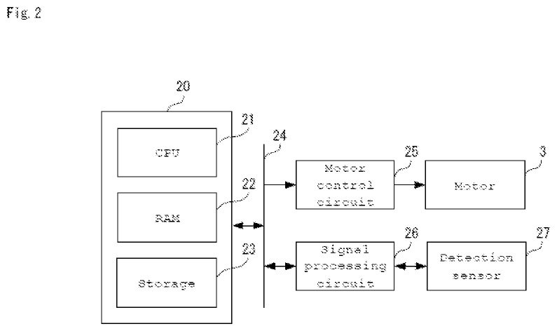

FIG. 2 is a block diagram illustrating an example of an electrical configuration of the dispensing apparatus 1 according to an embodiment of the present invention. As illustrated in FIG. 2, the dispensing apparatus 1 includes a control device 20, a motor control circuit 25, a signal processing circuit 26, and a detection sensor 27 in addition to the motor 3 and the like.

The control device 20, the motor control circuit 25, and the signal processing circuit 26 are electrically connected to each other via a circuit 24 such as a bus. The motor 3 is connected to the motor control circuit 25, and the detection sensor 27 is connected to the signal processing circuit 26.

The control device 20 is responsible for overall control of the dispensing apparatus 1. The control device 20 includes a central processing unit (CPU) 21. The control device 20 further includes a random access memory (RAM) 22 and a storage 23 that can be directly accessed by the CPU 21.

The CPU 21 controls each component of the dispensing apparatus 1. The RAM 22 is used as a work area and a buffer area of the CPU 21. The storage 23 is a nonvolatile memory, and for example, a hard disc drive (HDD), a solid state drive (SSD), or the like is used as the storage 23.

The storage 23 stores a control program for controlling each component of the dispensing apparatus 1, data (execution data) required for executing the control program, and the like. Note that the storage 23 may include the RAM 22.

The motor control circuit 25 generates a voltage (drive voltage) for driving the motor 3 and applies the drive voltage to the motor 3.

The signal processing circuit 26 is a circuit for processing a signal output from the detection sensor 27, and the signal processing circuit 26 includes, for example, an amplifier circuit for amplifying the signal output from the detection sensor 27. The signal processing circuit 26 further includes a circuit for supplying power to the detection sensor 27.

Although described in detail later, the detection sensor 27 is provided to detect a state of the drive transmitter 5. In the present embodiment, a general-purpose proximity sensor is used as the detection sensor 27.

As long as the state of the drive transmitter 5 can be detected, another non-contact sensor such as an optical sensor or an ultrasonic sensor may be used as the detection sensor 27, or a contact sensor may be used as the detection sensor 27.

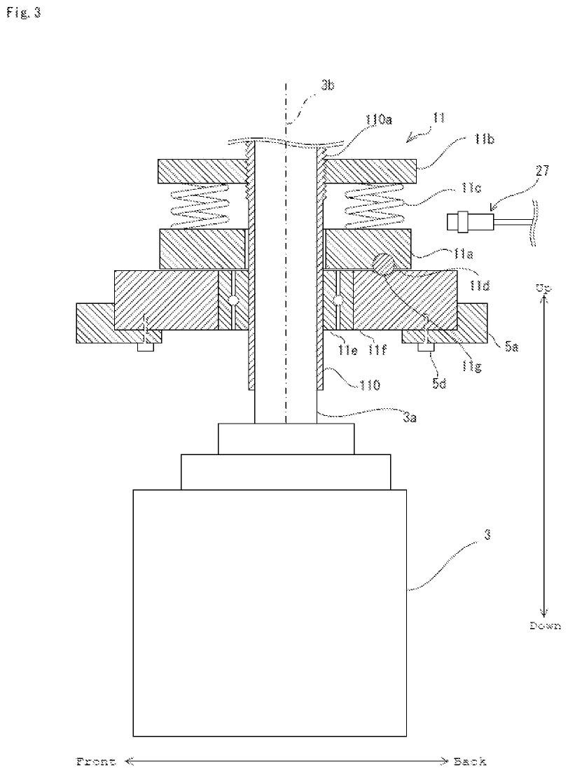

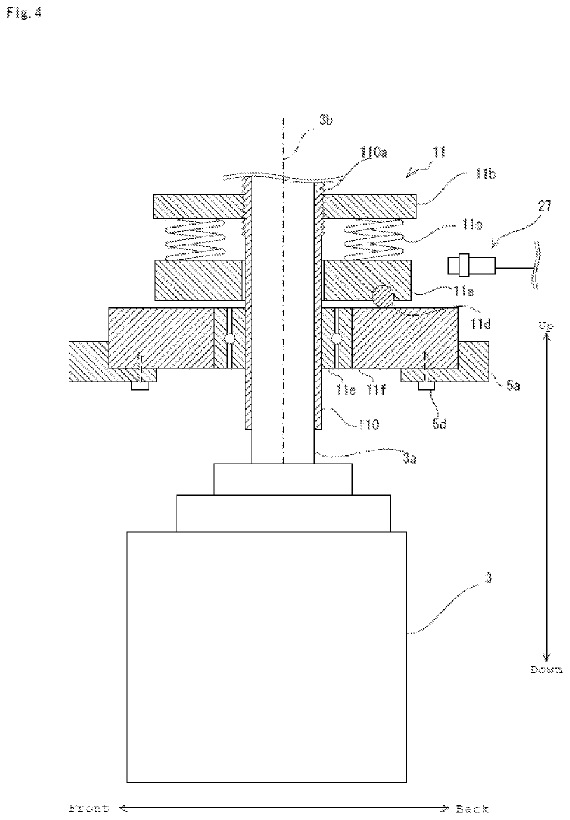

Although not illustrated in FIG. 1, the detection sensor 27 is provided in a periphery of the transmission switch 11 (see FIGS. 3 and 4).

### 3. Configuration of Periphery of Transmission Switch

FIGS. 3 and 4 are sectional views illustrating an example of a schematic configuration of the periphery of the transmission switch 11 according to an embodiment of the present invention. FIG. 3 is a sectional view illustrating an example of a schematic configuration of the periphery of the transmission switch 11 in a case where the drive transmitter 5 corresponds to the transmission state. FIG. 4 is a sectional view illustrating an example of the schematic configuration of the periphery of the transmission switch 11 in a case where the drive transmitter 5 corresponds to the non-transmission state.

As illustrated in FIGS. 3 and 4, an attaching member 110 as a cylindrical member is fitted and fixed to the motor shaft 3a, and the transmission switch 11 is provided on the motor shaft 3a via the attaching member 110. The driving pulley 5a is provided on the attaching member 110 via the transmission switch 11. That is, the driving pulley 5a is provided on the motor shaft 3a via the transmission switch 11 and the attaching member 110.

The transmission switch 11 includes a pressing plate 11a, a fixing plate 11b, a plurality of biasing members 11c, a plurality of engaging members 11d, a bearing lie, and a rotating member 11f.

The pressing plate 11a and the fixing plate 11b are circular plates, and the pressing plate 11a is provided to be displaceable in the vertical direction by being inserted into the attaching member 110 at a position above the driving pulley 5a.

Further, the fixing plate 11b is attached to the attaching member 110 at a position above the pressing plate 11a. The pressing plate 11a and the fixing plate 11b are connected via the biasing member 11c, and rotate about the rotation axis 3b in synchronization with the rotation of the motor shaft 3a.

The biasing member 11c is provided in order to apply a load to the pressing plate 11a, and a compression spring is used as the biasing member 11c. In this case, as illustrated in FIGS. 3 and 4, the biasing member 11c is provided between the pressing plate 11a and the fixing plate 11b in the vertical direction.

Specifically, one end of the biasing member 11c abuts on a surface of the pressing plate 11a facing the fixing plate 11b, and the other end of the biasing member 11c abuts on a surface of the fixing plate 11b facing the pressing plate 11a.

Further, the biasing member 11c is provided and compressed between the pressing plate 11a and the fixing plate 11b. In the examples illustrated in FIGS. 3 and 4, a downward load caused by the biasing member 11c is applied to the pressing plate 11a.

Teeth 110a that function as a screw are formed on the attaching member 110, and the fixing plate 11b is screwed into the attaching member 110. By adjusting a screwing amount of the fixing plate 11b, a distance between the fixing plate 11b and the pressing plate 11a can be changed. Accordingly, the load applied to the pressing plate 11a can be adjusted by changing a compression amount of the biasing member 11c.

In the present embodiment, the driving pulley 5a is provided on the attaching member 110 via the bearing 11e and the rotating member 11f. Specifically, an inner ring of the bearing 11e is attached to an outer peripheral surface of the attaching member 110, and the rotating member 11f is attached to an outer ring of the bearing 11e. The driving pulley 5a is fixed to the rotating member 11f using a fixing tool 5d such as a screw.

Instead of the bearing 11e as a general-purpose rolling bearing, a general-purpose sliding bearing may be used.

The plurality of engaging members 11d has a substantially spherical shape, and is provided in order to synchronously rotate the pressing plate 11a and the rotating member 11f. The engaging members 11d are provided so as to protrude from a surface of the pressing plate 11a facing the driving pulley 5a. When the pressing plate 11a rotates, each of the engaging members 11d similarly rotates about the rotation axis 3b.

A plurality of recesses 11g for fitting the engaging members 11d is formed on a surface of the rotating member 11f facing the pressing plate 11a. The recesses 11g have a substantially conical shape recessed downward. Further, as illustrated in FIG. 3, each of the recesses 11g is formed such that the pressing plate 11a and the rotating member 11f do not abut each other when the engaging members 11d are fitted into the recesses 11g corresponding to the engaging members 11d.

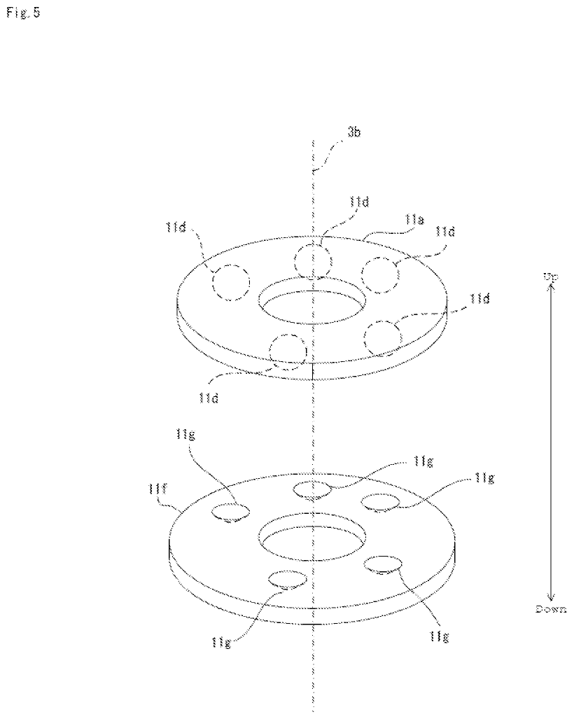

FIG. 5 is a schematic view illustrating a schematic configuration of the periphery of the pressing plate 11a and the rotating member 11f according to an embodiment of the present invention as viewed obliquely. FIG. 5 does not illustrate the motor shaft 3a, the bearing 11e, the attaching member 110, and the like.

As described above, the plurality of recesses 11g is formed in the rotating members 11f, and the plurality of engaging members 11d is provided on the pressing plate 11a. In the present embodiment, when each of the recesses 11g overlaps each of the paired engaging members 11d in the vertical direction, each of the engaging members 11d is fitted into each of the recesses 11g.

In the embodiment, as shown in FIG. 5, the plurality of recesses 11g is formed in the rotating member 11f at positions where distances from the recesses 11g to the rotation axis 3b are the same and distances between the recesses 11g in a circumferential direction are different from each other.

As a result, when the pressing plate 11a is rotated by one round relative to the rotating member 11f, the engaging members 11d corresponding to the recesses 11g on a one-to-one basis are fitted only at one specific rotational position. That is, when the pressing plate 11a is relatively rotated by one round, the engaging members 11d are fitted into the respective recesses 11g only at one specific rotational position.

Alternatively, for example, the plurality of recesses 11g may be formed in the rotating member 11f at positions where the distances between the recesses 11g in the circumferential direction are the same and the distances from the recesses 11g to the rotation axis 3b are different from each other.

Further, the plurality of recesses 11g may be formed in the rotating member 11f at positions where distances from the recesses 11g to the rotation axis 3b are different from each other and distances between the recesses 11g in the circumferential direction are different from each other. The same applies to a position where the engaging members 11d are provided.

The upper limit value of the overload on the motor 3 is determined in accordance with the screwing amount of the fixing plate 11b, that is, a compression displacement amount of the biasing members 11c, a protruding amount of the engaging members 11d, a shape of the engaging members 11d, a depth of the recesses 11g, a shape of the recesses 11g, and the like. The upper limit value of the overload on the motor 3 is set to a value in a range in which the motor 3 does not step out.

When the drive transmitter 5 is in the transmission state, as shown in FIG. 3, the engaging members 11d are fitted into the corresponding recesses 11g. When the motor shaft 3a rotates, the engaging members 11d are caught by the recesses 11g, and the driving pulley 5a rotates in synchronization with the pressing plate 11a and the fixing plate 11b.

When the drive transmitter 5 is in the transmission state and the overload on the motor 3 exceeds the upper limit value, slippage occurs on ground contact surfaces of the engaging members 11d and the recesses 11g, and the engaging members 11d fitted in the recesses 11g are disengaged from the recesses 11g. When the engaging members 11d are disengaged from the recesses 11g, the drive transmitter 5 is switched from the transmission state to the non-transmission state.

When the drive transmitter 5 is in the non-transmission state, the engaging members 11d are in slidable contact with the surface of the rotating member 11f facing the pressing plate 11a.

In this case, the pressing plate 11a and the fixing plate 11b rotate with the rotation of the motor shaft 3a, but the rotating member 11f and the driving pulley 5a do not rotate because the engaging members 11d rotate about the rotation axis 3b in slidable contact with the rotating member 11f.

As illustrated in FIG. 5, since the engaging members 11d fitted in the recesses 11g are in slidable contact with the rotating member 11f at a position where the recesses 11g are not formed, the position of the pressing plate 11a is displaced upward.

Since the detection sensor 27 is provided in a periphery of the transmission switch 11, the displacement of the pressing plate 11a is detected by the detection sensor 27. The pressing plate 11a is displaced by switching of the state of the drive transmitter 5, and thus the state of the drive transmitter 5 is detected from the signal output from the detection sensor 27.

In the dispensing apparatus 1 configured as described above, when the plurality of tips 9 held by the tip holder 7 is attached to the tip attaching and detaching unit 6, upon detection of the non-transmission state of the drive transmitter 5 by the detection sensor 27, that is, with the overload on the motor 3 exceeding the upper limit value, the driving of the motor 3 is temporarily stopped. When the driving of the motor is stopped, the motor 3 is driven again in order to switch (return) the drive transmitter 5 from the non-transmission state to the transmission state.

In a case where the motor shaft 3a is rotated in the same rotation direction as an immediately preceding rotation direction when the drive transmitter 5 is switched from the non-transmission state to the transmission state, there is a risk that the driving pulley 5a may rotate similarly, that is, the tip attaching and detaching unit 6 may be further displaced downward. That is, there is a risk that a load may be applied to the motor 3.

Therefore, in the present embodiment, in order to prevent a load from being applied to the motor 3 when the drive transmitter 5 is returned from the non-transmission state to the transmission state, the motor shaft 3a is rotated in a direction opposite to the immediately preceding rotation direction.

When the drive transmitter 5 is switched from the non-transmission state to the transmission state, in order to enhance accuracy of switching of the drive transmitter 5, the motor 3 is controlled to rotate the motor shaft 3a at least at a rotation speed slower than a rotation speed when the tips 9 are attached to the tip attaching and detaching unit 6, specifically, at a rotation speed slower than a rotation speed when the tip attaching and detaching unit 6 is brought close to the tip holder 7.

Furthermore, in the embodiment, when the drive transmitter 5 is switched from the non-transmission state to the transmission state, the rotation of the motor shaft 3a is continued, and the tip attaching and detaching unit 6 is separated from the tip holder 7.

After the tip attaching and detaching unit 6 is separated from the tip holder 7, for example, the tip attaching and detaching unit 6 is moved to another position along the horizontal direction, and the tips 9 attached to the tip attaching and detaching unit 6 are detached. An operation after the drive transmitter 5 is switched from the non-transmission state to the transmission state is not limited.

### 4. Memory Map

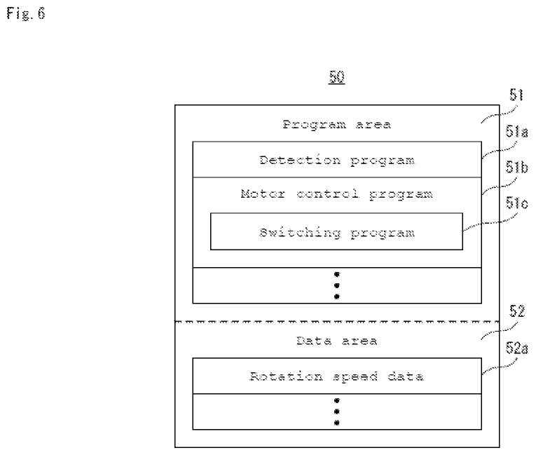

FIG. 6 is a diagram illustrating an example of a memory map 50 of the RAM 22 according to an embodiment of the present invention. As illustrated in FIG. 6, the RAM 22 includes a program area 51 and a data area 52, and the program area 51 stores a control program read in advance from the storage 23. The control program includes a detection program 51a, a motor control program 51b, and the like.

The detection program 51a is a program for detecting the transmission state or the non-transmission state of the drive transmitter 5 in accordance with a signal output from the detection sensor 27.

The motor control program 51b is a program for controlling the motor 3. The motor control program 51b includes a switching program 51c.

The switching program 51c is a program for temporarily stopping the driving of the motor 3 upon detection of the non-transmission state of the drive transmitter 5 by the detection program 51a when the tips 9 are attached to the cylinders 8, and then driving the motor 3 to rotate the motor shaft 3a in a rotation direction opposite to the immediately preceding rotation direction at least until the transmission state of the drive transmitter 5 is detected by the detection program 51a. When the motor shaft 3a is rotated in the direction opposite to the immediately preceding rotation direction in accordance with execution of the switching program 51c, rotation speed data 52a to be described later is used.

Although not illustrated, the program area 51 stores control programs other than the detection program 51a and the motor control program 51b.

The data area 52 stores execution data read from the storage 23 in advance. In the example illustrated in FIG. 6, the data area 52 store the rotation speed data 52a. The rotation speed data 52a is data indicating the rotation speed of the motor shaft 3a when the drive transmitter 5 is switched from the non-transmission state to the transmission state.

The data area 52 stores other execution data or temporarily stores data corresponding to the signal output from the detection sensor 27. Furthermore, the data area 52 is provided with a timer (counter) and a register necessary for execution of the control programs.

### 5. Specific Electrical Configuration of Dispensing Apparatus

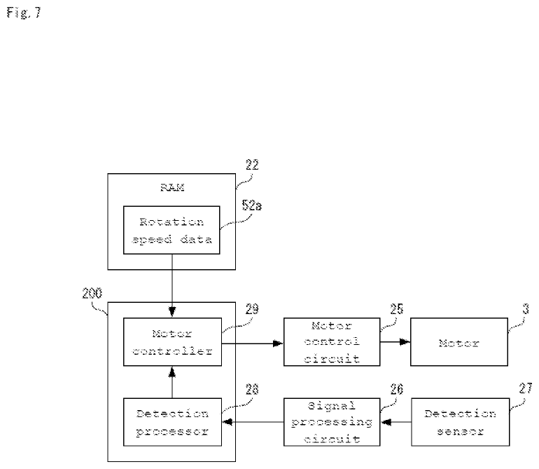

FIG. 7 is a block diagram specifically illustrating an electrical configuration of a dispensing apparatus according to an embodiment of the present invention. A controller 200 including the CPU 21 functions as a detection processor 28 that detects the transmission state or the non-transmission state of the drive transmitter 5 by the CPU 21 executing the detection program 51a, and functions as a motor controller 29 that controls the motor 3 by the CPU 21 executing the motor control program 51b.

In the example illustrated in FIG. 7, the controller 200 functions as the detection processor 28 and the motor controller 29. For example, when the tips 9 are attached to the cylinders 8, upon detection of the non-transmission state of the drive transmitter 5 by the detection processor 28, the motor controller 29 temporarily stops the driving of the motor 3, and then controls the motor 3 to rotate the motor shaft 3a in the rotation direction opposite to the immediately preceding rotation direction using the rotation speed data 52a stored in the RAM 22 at least until the detection processor 28 detects the transmission state of the drive transmitter 5. Note that the rotation speed data 52a stored in the storage 23 may be used.

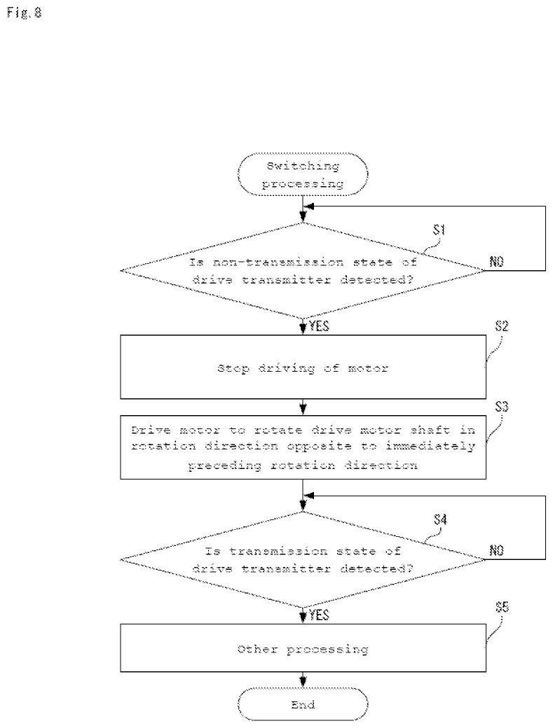

FIG. 8 is a flowchart illustrating an example of switching processing of the CPU 21 according to an embodiment of the present invention. The switching processing starts, for example, when the tips 9 are attached to the cylinders 8.

In step S1, it is determined whether the non-transmission state of the drive transmitter 5 is detected. When “NO” is determined in step S1, that is, when the transmission state of the drive transmitter 5 is detected, step S1 is repeated. On the other hand, when “YES” is determined in step S1, that is, when the non-transmission state of the drive transmitter 5 is detected, the processing proceeds to step S2.

In step S2, the driving of the motor 3 is stopped, and when a predetermined time has elapsed, the processing proceeds to step S3.

In step S3, the motor 3 is driven to rotate the motor shaft 3a in the rotation direction opposite to the immediately preceding rotation direction. In step S4 subsequent to step S3 while the motor shaft 3a is rotated by about one round (for example, 380°), it is determined whether the transmission state of the drive transmitter 5 is detected.

When “NO” is determined in step S4, that is, when the non-transmission state of the drive transmitter 5 is detected, step S4 is repeated. On the other hand, when “YES” is determined in step S4, that is, when the transmission state of the drive transmitter 5 is detected, other processing is executed in step S5. The other processing here is, for example, processing for continuing driving of the motor 3 and detaching the tips 9 attached to the tip attaching and detaching unit 6.

### 6. Modification

In the present embodiment, the drive transmitter 5 may include other members such as a gear and a shaft. In this case, at least the driving pulley 5a and the driven pulley 5b are replaced with a general-purpose gear.

Further, the transmission switch 11 need not to be provided on the motor shaft 3a, and may be provided on any other member constituting the drive transmitter 5.

Furthermore, when the drive transmitter 5 is switched from the non-transmission state to the transmission state, the motor shaft 3a may be rotated in the same direction as the immediately preceding rotation direction. In this case, when the drive transmitter 5 is switched from the non-transmission state to the transmission state, the motor shaft 3a is rotated in the rotation direction opposite to the immediately preceding rotation direction, and the tip attaching and detaching unit 6 is separated from the tip holder 7.

When the drive transmitter 5 is switched from the non-transmission state to the transmission state, the motor shaft 3a may be rotated by about one round regardless of the signal output from the detection sensor 27. However, in this case, the motor shaft 3a is rotated in the rotation direction opposite to the immediately preceding rotation direction.

Further, when the drive transmitter 5 is switched from the non-transmission state to the transmission state, the motor 3 is driven again after the driving of the motor 3 is temporarily stopped, but the driving of the motor 3 may be continued.

### 7. Aspect

It is understood by those skilled in the art that the exemplary embodiments described above are specific examples of the following aspects.

(Item 1) A dispensing apparatus according to an aspect is a dispensing apparatus that sucks and discharges liquid through a tip, the dispensing apparatus may include

a motor,

a motor controller configured to control the motor,

a tip attaching and detaching unit allowing attachment and detachment of a plurality of the tips,

a tip holder configured to hold the plurality of tips,

a support member configured to support the tip attaching and detaching unit in a displaceable manner, and

a drive transmitter configured to transmit a driving force of the motor to the support member, in which

the drive transmitter may include a transmission switch that switches the drive transmitter from a transmission state in which the driving force of the motor is transmitted to a non-transmission state in which transmission of the driving force of the motor is blocked when an overload on the motor exceeds an upper limit value in a case where the plurality of tips held by the tip holder is attached to the tip attaching and detaching unit along with a displacement of a position of the tip attaching and detaching unit.

In the dispensing apparatus according to item 1, it is possible to prevent an overload exceeding an upper limit value from being applied to the motor when the plurality of tips is attached to the tip attaching and detaching unit due to a displacement of the tip attaching and detaching unit, and it is therefore possible to reduce a load applied to the motor.

In addition, since the upper limit value of the motor is not exceeded, the plurality of tips can be attached to the tip attaching and detaching unit with a constant force.

(Item 2) In the dispensing apparatus according to item 1,

the motor may further include a motor shaft that rotates about a rotation axis, and

the transmission switch may be provided on the motor shaft.

In the dispensing apparatus according to item 2, the load on the motor is reduced only by providing the transmission switch near the motor, and thus the load on the motor can be reduced without providing a large installation space. In addition, for example, a conventional dispensing apparatus can be easily improved to a dispensing apparatus having a function of reducing a load applied to a motor.

(Item 3) The dispensing apparatus according to item 1 or 2 may further include

a detector configured to detect the non-transmission state of the drive transmitter, in which

upon detection of the non-transmission state by the detector when the plurality of tips held by the tip holder is attached to the tip attaching and detaching unit, the motor controller may control the motor to rotate in a rotation direction opposite to an immediately preceding rotation direction.

In the dispensing apparatus according to item 3, in a case where the drive transmitter is switched from the transmission state to the non-transmission state when the plurality of tips is attached to the tip attaching and detaching unit due to the displacement of the tip attaching and detaching unit, the drive transmitter can be returned from the non-transmission state to the transmission state.

In the dispensing apparatus according to item 3, the motor rotates in the rotational direction opposite to the immediately preceding rotational direction, and thus the drive transmitter can be returned from the non-transmission state to the transmission state without applying a load to at least the motor.

Furthermore, for example, in a case where the tip attaching and detaching unit is separated from the tip holder along with replacement of the tips after the drive transmitter is returned from the non-transmission state to the transmission state, it is sufficient to continuously rotate the motor after the drive transmitter returns from the non-transmission state to the transmission state. That is, the tip attaching and detaching unit and the tip holder can be separated more easily than when the tip holder is not rotated backward.

(Item 4) In the dispensing apparatus according to item 3,

when the motor controller controls the motor to rotate in the rotation direction opposite to the immediately preceding rotation direction, the motor controller may control the motor to rotate at a rotation speed lower than at least a rotation speed when the plurality of tips is attached to the tip attaching and detaching unit.

The dispensing apparatus according to item 4 can improve the accuracy when the drive transmitter is switched from the non-transmission state to the transmission state.

1. A dispensing apparatus that sucks and discharges liquid through a tip, the dispensing apparatus comprising:
a motor;
a motor controller configured to control the motor;
a tip attaching and detaching unit allowing attachment and detachment of a plurality of the tips;
a tip holder configured to hold the plurality of tips;
a support member configured to support the tip attaching and detaching unit in a displaceable manner; and
a drive transmitter configured to transmit a driving force of the motor to the support member,
wherein the drive transmitter includes a transmission switch that switches the drive transmitter from a transmission state in which the driving force of the motor is transmitted to a non-transmission state in which transmission of the driving force of the motor is blocked when an overload on the motor exceeds an upper limit value in a case where the plurality of tips held by the tip holder is attached to the tip attaching and detaching unit along with a displacement of the tip attaching and detaching unit.

2. The dispensing apparatus according to claim 1, wherein
the motor further includes a motor shaft that rotates about a rotation axis, and
the transmission switch is provided on the motor shaft.

3. The dispensing apparatus according to claim 1, further comprising a detector configured to detect the non-transmission state of the drive transmitter, wherein
upon detection of the non-transmission state by the detector when the plurality of tips held by the tip holder is attached to the tip attaching and detaching unit, the motor controller controls the motor to rotate in a rotation direction opposite to an immediately preceding rotation direction.

4. The dispensing apparatus according to claim 3, wherein when the motor controller controls the motor to rotate in the rotation direction opposite to the immediately preceding rotation direction, the motor controller controls the motor to rotate at a rotation speed lower than at least a rotation speed when the plurality of tips is attached to the tip attaching and detaching unit.
